(19) United States
(12) Patent Application Publication
(10) Pub. No.: US 2017/0262617 A1
(43) Pub. Date: Sep. 14, 2017

(54) ACTIVITY TRACKING DEVICE

(71) Applicant: Virgin Pulse, Inc., Framingham, MA (US)

(72) Inventor: Chiang Ying Yi, Holliston, MA (US)

(21) Appl. No.: 15/583,649

(22) Filed: May 1, 2017

Related U.S. Application Data
(62) Division of application No. 14/464,215, filed on Aug. 20, 2014.
(60) Provisional application No. 61/871,153, filed on Aug. 28, 2013.

(51) Int. Cl. G06F 19/00

(52) U.S. Cl. CPC G06F 19/3481

(57) ABSTRACT

An activity tracking device has a display screen, a data store, a main processor communicatively coupled with the data store, a device profile configuration stored in the data store, and a user profile configuration stored in the data store. The device profile configuration has a device identifier, processor identifiers, and device statuses. The user profile configuration has a user identifier, and a minimum user activity parameter. The minimum user activity parameter is determined based on one or more historical activity parameters resulting from actual user activity as tracked by the activity tracking device, stored in the data store, and configured in the user profile configuration.

### RELATED APPLICATIONS

This application is a divisional of, and claims priority to and the benefit of, co-pending U.S. application Ser. No. 14/464,215, filed Aug. 20, 2014, which claims priority to and the benefit of U.S. Provisional Application No. 61/871,153, filed Aug. 28, 2013, for all subject matter common to said applications. The disclosures of said applications are hereby incorporated by reference in their entirety.

### FIELD OF THE INVENTION

The present invention relates to a network supported health and fitness system and more specifically to a method and apparatus for interactive web-supported health and fitness systems utilizing devices to track user activity with on-line communication functionality between the device and a central data center.

### BACKGROUND OF THE INVENTION

Various automated systems exist for promoting and maintaining health and wellness. Some of these systems are directed to healthcare data management used by heath care professionals, patients, or both. Of the healthcare data management systems, some monitor and record vital statistics.

Other automated systems are directed to fitness and monitoring of healthy behavior and activities. Some form of measuring and monitoring biometrics is typical in these systems. Such systems are used by, for example, fitness professionals, physical therapists, trainers, etc. Some fitness programs provide incentives or rewards to the participant for reaching certain milestones.

Although conventional systems and devices are able to record and display user activity, however, displays are not updated quickly and often. Also, the conventional devices only record and display total activity (for example total steps recorded for the user for each activity or cumulative steps over a period of time). Additionally, some conventional devices are pedometers with the ability to convert steps into a distance based on measured number of steps and measured stride length.

### SUMMARY

There is a need to provide real-time recording and display of user activity data. There is a need for a device that can provide an indication of a user's progress and how well the user is performing with respect to predetermined minimum desired user activity levels. In particular, there is a need for a device that can provide messages of encouragement or other motivational techniques based on the level of activity for a particular user of the device. The present invention is directed toward further solutions to address these needs, in addition to having other desirable characteristics.

In accordance with an embodiment of the present invention, an activity tracking device has a display screen, a data store, a main processor communicatively coupled with the data store, a device profile configuration stored in the data store, and a user profile configuration stored in the data store. The device profile configuration has a device identifier, a plurality of processor identifiers, and a plurality of device statuses. The user profile configuration has a user identifier, and a minimum user activity parameter. The minimum user activity parameter is determined based on one or more historical activity parameters resulting from actual user activity as tracked by the activity tracking device, stored in the data store, and configured in the user profile configuration.

In accordance with aspects of the present invention, the minimum user activity parameter is determined by an external server. In another aspect, the minimum user activity parameter is determined by the device.

In accordance with aspects of the present invention, the minimum user activity parameter is calculated based on a number of steps recorded by the device during a selected time duration. In another aspect, the minimum user activity is set at a factory default when the device contains no historical user activity parameters in the data store.

In accordance with aspects of the present invention, the actual user activity is measured by the device as data that has number of steps data and duration data. In another aspect, an activity parameter has a current real-time calculation of recent actual user activity over time. The activity parameter can be compared against the minimum user activity parameter.

In accordance with aspects of the present invention, the user profile configuration has an indicator of user selection of a messaging library, selected from a plurality of messaging libraries. The plurality of messaging libraries can include a graphical messaging library, humorous messaging library, a non-humorous messaging library, a motivating messaging library, a themed messaging library, an informative messaging library, a coaching messaging library, or combinations thereof.

In accordance with aspects of the present invention, the user profile configuration has an indicator of user selection of units of measurement utilized by the device. In another aspect, the user profile configuration includes an indicator of user selection of notification preferences implemented by the device. In another aspect, the user profile configuration includes an indicator of user selection of activities available for recommendation by the device to the user.

In accordance with aspects of the present invention, the display screen is configured for display of one or more of total number of steps taken by a user, activity parameter, total number of calories burned, total distance travelled by a user, progress indicator toward user daily steps goal, physical activity intensity indicator, synchronization progress indicator, or a clock with the current time. In another aspect, the display screen is configured for display of one or more scenarios based on at least one rule. The one or more scenarios can be a challenge between users, battery settings, encouraging a user based on the actual user activity, encouraging a user based on the user not having worn the activity tracking device, activation of the activity tracking device, morning wake up, upload reminder, achieving goals, firmware update, or combinations thereof.

In accordance with aspects of the present invention, the one or more historical activity parameters resulting from the actual user activity are calculated by dividing a total number of steps recorded by a total time duration during which the steps were recorded.

In accordance with aspects of the present invention, the device includes a pedometer.

In accordance with aspects of the present invention, the device includes environmental information stored in the data store. The environmental information can be based on an actual real-time user environment. In another aspect, the device includes environmental information stored in the data store. The environmental information can be based on a predicted user environment at a future time when the user is scheduled for an activity.

In accordance with aspects of the present invention, the device includes user calendar information stored in the data store. In another aspect, the device includes user nutritional intake information stored in the data store.

In accordance with aspects of the present invention, the device includes a motion sensor in communication with the main processor.

In accordance with aspects of the present invention, the device includes a history analyzer in communication with the data store and the main processor such that the history analyzer is configured to restore data to the data store. The data is one or more of total number of steps recorded, calories, distance, progress toward a goal, activity parameters, and the minimum user activity parameter.

In accordance with aspects of the present invention, the device generates one or more messages on the display screen. The message(s) can be based on one or more of environmental information, user calendar information, user nutritional intake information, the user profile configuration, time, or physical activity.

In accordance with aspects of the present invention, the activity tracking device is configured for wireless communication or wired communication with a computing device or an additional device. The wireless communication can be one or more of radio frequency communications such as cellular, IEEE 802.11 format, IEEE 802.15.1 format, IEEE 802.15 format, or Bluetooth® low energy wireless formats. The wired communication can be Universal Serial Bus (USB) format. For example, the wired communication can be USB 2.0 and USB 3.0 compatible. The additional device can be a second activity tracking device, a cyclometer, or a weight scale.

In accordance with an embodiment of the present invention, a method of initiating an activity challenge between two or more users includes a first activity tracking device having a first user profile configuration stored in a data store. The method includes a second activity tracking device having a second user profile configuration stored in a data store. The first activity tracking device can be set to a challenge mode. The first activity tracking device and the second activity tracking device are bumped against each other. This causes an electronic wireless communication to occur between the first activity tracking device and the second activity tracking device. The electronic communication initiates the activity challenge between the first activity tracking device and the second activity tracking device.

In accordance with an embodiment of the present invention, a method synchronizes an activity tracking device with a computing device. The activity tracking device is positioned proximal to the computing device. A wireless synchronizing process is initiated.

In accordance with aspects of the present invention, the step of initiating the wireless synchronizing process has a user pressing a button on the activity tracking device for a selected time duration. In another aspect, the step of positioning requires an arrangement of the activity tracking device and the computing device in such a way that places the computing device in proximity to a user executing the positioning step.

In accordance with an embodiment of the present invention, a method synchronizes an activity tracking device with a computing device. The activity tracking device is electronically coupled to the computing device. A wired synchronizing process is initiated.

### BRIEF DESCRIPTION OF THE FIGURES

These and other characteristics of the present invention will be more fully understood by reference to the following detailed description in conjunction with the attached drawings, in which:

FIG. 1 is a schematic view of an activity tracking device according to an embodiment of the present invention;

FIGS. 2A and 2B are a schematic view of an example system including the activity tracking device interacting with a computing/mobile device and an external server(s) according to one aspect of the present invention;

FIG. 3 depicts display screen views of example messages displayed on a display screen of the activity tracking device according to one aspect of the present invention;

FIGS. 4A, 4B and 4C illustrate display screen views of the messages displayed for each scenario of a number of example scenarios that can occur with the activity tracking device according to one aspect of the present invention;

FIGS. 5A and 5B are display screen views of an example implementation using the activity tracking device for different functions in a flow chart format according to one aspect of the present invention;

FIG. 6 is a schematic view of a bumping action and thereafter communication between two activity tracking devices, according to an embodiment of the present invention;

FIG. 7 is a flowchart illustrating an example method of implementation of the activity tracking device, according to an embodiment of the present invention;

FIG. 8 is a flowchart illustrating an example method of implementation of the activity tracking device, according to an embodiment of the present invention; and

FIG. 9 is a schematic view of the activity tracking device or the computing/mobile device, suitable for implementing the present invention.

### DETAILED DESCRIPTION

An illustrative embodiment of the present invention relates to an activity tracking device that has a display screen, a data store, a main processor coupled with the data store, a device profile configuration stored in the data store, and a user profile configuration stored in the data store. The device profile configuration has a device identifier, processor identifiers, and device statuses. The user profile configuration has a user identifier and a minimum user activity parameter. The minimum user activity parameter is determined based on historical activity parameters resulting from actual user activity as tracked by the activity tracking device, stored in the data store, and configured in the user profile configuration.

Notably, the activity tracking device is configured to track and record the actual user activity of a user against a minimum user activity parameter. The minimum user activity parameter varies based on the level of activity of a user. This range can include users that are highly active (i.e., running 5-10 miles every day) to not very active (i.e., walking 1 mile a week). Also, the minimum user activity can change based on the user's historical activity parameters. For example, the actual user activity for a user may decrease significantly in the winter, thus their minimum user activity parameter can adjust to reflect this environmental impact. In another example, as a user becomes more active (e.g., increases the number of miles run each week, or the frequency of running), the minimum user activity parameter can be increased. Based on a comparison of a user's activity parameter to a minimum user activity parameter configured in their activity tracking device, encouraging messages can be sent to the user on the activity tracking device. These messages can vary based on a user's level of activity as well as how large of a difference there is between the user's activity parameter and their minimum user activity parameter.

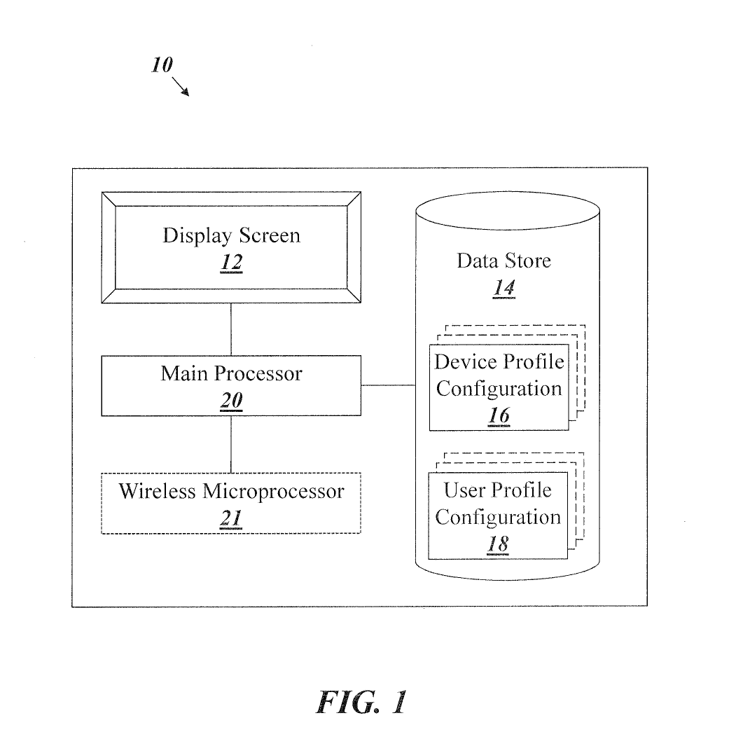

FIGS. 1 through 9, wherein like parts are designated by like reference numerals throughout, illustrate an activity tracking device according to the present invention. Although the present invention will be described with reference to the figures, it should be understood that many alternative forms can embody the present invention. One of ordinary skill in the art will additionally appreciate different ways to alter the parameters disclosed, such as the size, shape, or type of elements or materials, in a manner still in keeping with the spirit and scope of the present invention.

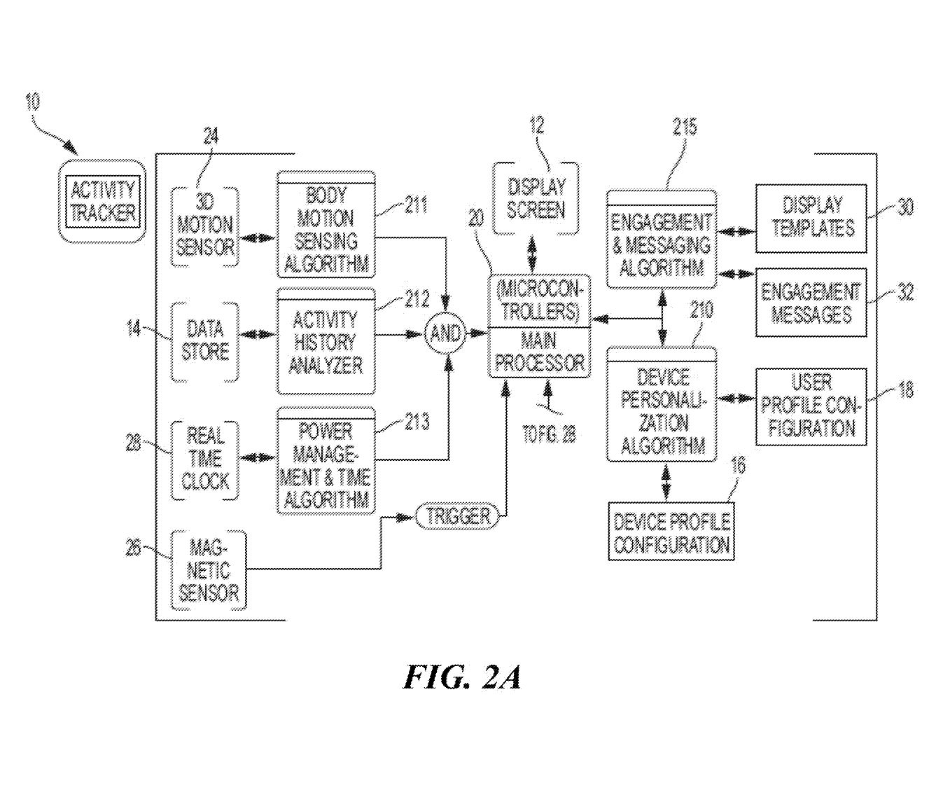

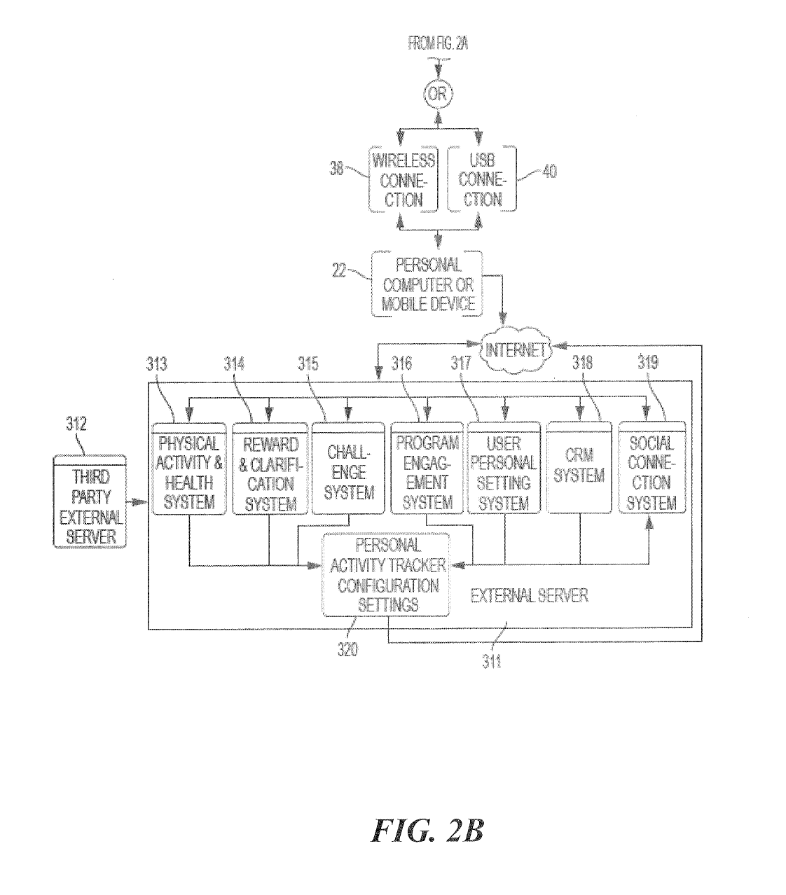

FIG. 1 illustrates a schematic view of an activity tracking device 10 according to an example embodiment of the present invention. FIGS. 2A and 2B illustrate an example system including the activity tracking device 10 interacting with a computing/mobile device 22 and external server(s) 311. The activity tracking device 10 can be continuously updated minute-by-minute or hour-by-hour, as desired. The activity tracking device 10 can be pre-programmed or can be programmed at the back end (e.g., by an external server).

The activity tracking device 10 includes reactive and proactive aspects. Reactive aspects include features such as rewards and messages. Proactive aspects are based on history of the user, trying to motivate the user to perform some act, user did act, or user should do act. An actual “user activity” refers to a user performing an activity such as walking or running. An “activity parameter” refers to calculation of steps over a certain period of time. A “minimum user activity parameter” refers to setting a device to a desired level of an activity parameter that should be achieved by that particular user. The minimum user activity parameter can be set as a default initially and can be influenced by the user using the activity tracking device 10, which can cause repeated calculations of the activity parameter to occur that can change the minimum user activity parameter over time. The minimum user activity parameter can be equivalent to a threshold level.

The activity tracking device 10 can be a pedometer. In particular, the pedometer can be an uploadable pedometer. An uploadable pedometer allows for the activity tracking device 10 to be connected with a computing/mobile device 22 such that data generated by the pedometer can be transferred to the computing/mobile device 22 and in some examples to a website or mobile application acting as an interface for an external server 311. This generated data can be transferred from the computing/mobile device 22 to an external server 311 for tracking of a user's progress. As a pedometer, the activity tracking device 10 is capable of measuring or counting (e.g., tracking) steps taken by a user. The activity tracking device 10 can include a clip or wristband accessory for coupling the activity tracking device 10 to a user.

The activity tracking device 10 includes a display screen 12 (e.g., a device graphical display). The display screen 12 can be a simple numeric display. The display screen 12 is configured to display speed/distance recorded over a duration of time and displayed back to the user at a desired frequency, e.g., minute-by-minute or hour-by-hour. In one example, there can be three display modes: total number of steps taken by a user (e.g., cumulative total steps), activity parameter (e.g., total number of steps in a minute), and a clock with the current time. Other display modes can include total number of calories burned, total distance travelled by a user, a progress indicator toward user daily steps or other goals (e.g., the progress indicator can be displayed in animated form), a physical activity intensity indicator, a synchronization progress indicator, and/or a clock. The display screen 12 can show a host of other information such as various messages including updates on how well a user is doing with respect to exercise or activity goals for example, congratulatory messages based on accomplishments, or motivational messages to prod the user into more activity. In one example, the display screen 12 can be a two-dimensional graphical display. In another example, the display screen 12 can be a Sharp memory thin-film transistor type display. The display screen 12 can be ultra-thin such as 0.6 mm thick.

The activity tracking device 10 includes a data store 14. The data store 14 can be a flash memory, or other form of data storage as would be readily appreciated by those of skill in the art. A device profile configuration 16 (i.e., data about the device itself) and a user profile configuration 18 (i.e., data about the user) can be stored in the data store 14 as shown in FIG. 1. In another example, the device profile configuration 16 and user profile configuration 18 are separate from the data store 14 as shown in FIGS. 2A and 2B.

The device profile configuration 16 can include a device identifier, processor identifiers, and device statuses. The device identifier and processor identifiers are used for recognizing a particular activity tracking device 10. The device statuses are utilized for tracking the current state of the hardware of the activity tracking device 10. For example, if a battery of the activity tracking device 10 is low, the device statuses may be configured to track a level of energy in the battery and send such information to be displayed by the display screen 12. In one example, the battery is a single non-rechargeable CR2032 or a button cell lithium battery. However, one of skill in the art will appreciate that a number of different battery sizes and types may be utilized to power the device of the present invention.

The user profile configuration 18 includes a user identifier and a minimum user activity parameter. A user identifier is important for recognizing that a specific user corresponds with each activity tracking device 10. The user identifier can be in the form of a module which communicates with the main processor 20. In particular, the user identifier is configured to correlate a specific user with a particular activity tracking device 10. This allows for the activity tracking device 10 to adjust the minimum user activity parameter based on an activity level of that particular user. For example, one user may be considered a very active user (e.g., going to the gym at least 5-6 times a week) versus another user that can be considered a lower active user (e.g., exercises once every other week). The user identifier can categorize a user based on these levels of activity. Thus, the system can provide the relevant feedback needed for the particular user based on their level of activity.

The minimum user activity parameter can be determined based on historical activity parameters that result from actual user activity. In particular, the historical activity parameters can result from actual user activity that is calculated for each historical user activity. This calculation can be performed or processed by dividing a total number of steps recorded (for a particular user) by a total time duration (such as a minute). This total time duration is the period of time when the steps were recorded historically. For example, the total time duration could be in minutes, hours, days, weeks, months, or within a year. For example, a minimum user activity parameter can be 135 steps/minute. The activity tracking device 10 is configured with the rest of the system to change the minimum user activity parameter if desired such as from 135 steps/minute to 150 steps/minute for example.

As the activity parameters adjust based on the user activity, the historical activity parameters change as well. The result of the historical activity parameters are constantly being reviewed by the main processor 20 such that the minimum user activity parameter is adjusted accordingly. This allows for the main processor 20 to receive constant feedback as to the minimum user activity parameter for the user thus changing the user's designated level of activity. Based on this changing level of activity, the main processor 20 can communicate with the other components of the activity tracking device 10 to supply relevant messages to the particular user.

The actual user activity can be tracked by the activity tracking device 10, stored in the data store 14, and configured in the user profile configuration 18. In one example, the minimum user activity parameter is determined by an external server 311. In particular, the external server 311 can be used to determine the minimum user activity parameter by analyzing a user profile and/or activity data that was stored in the data store 14 for a particular user. The activity parameter can be configured into the activity tracking device 10 during a synchronization process from the external server 311 to the activity tracking device 10. In another example, the minimum user activity parameter is determined by the activity tracking device 10 using the main processor 20 coupled with the data store 14.

In one example, the minimum user activity parameter is calculated based on an actual number of steps that are recorded by the activity tracking device 10 during a selected time duration. In another example, the minimum user activity is set at a factory default range where the data store 14 contains no historical activity parameters.

The actual user activity is measured by the activity tracking device 10 as data that can be defined by number of steps data and duration data (i.e., X number of steps in a minute). An activity parameter is defined by a real-time calculation of recent actual user activity over time. This activity parameter can be compared with the minimum user activity parameter to determine a user's activity level (e.g., very active or not very active with regard to walking or running).

The user profile configuration 18 includes an indicator of user selection of a messaging library. The messaging library can be selected from a group of messaging libraries. For example, the group of messaging libraries can include a graphical messaging library (e.g., messages that are graphic-based such as hearts or sunshine pictures that do not require text based messaging), humorous messaging library (e.g., funny messages such as “You've been running through my mind”), a non-humorous messaging library (conservative messages), a motivating messaging library (e.g., “Lets Go!), a themed messaging library (e.g., based on a sports team or other subjects), informative messaging library (e.g., provides user with random facts related to running or eating healthy), or coaching messaging library (e.g., coach users with advice on better physical or health habits and/or activities). Other variations of libraries can be included as would be readily appreciated by those of skill in the art. Having a variety of library options allows for the activity tracking device 10 to be customized for each user and/or the organization providing the activity tracking devices 10 to users. For example, in one instance the user or organization may appreciate the humorous messaging library as to be used with their activity tracking device 10. However, in another example, the user or organization may be more conservative and could be offended by the humorous messaging thus preferring the non-humorous messaging library. Thus, the user profile configuration 18 can be configured specifically for each user or organization accordingly.

In one example, the user profile configuration 18 includes an indicator designating a user selection of units of measurement utilized by the activity tracking device 10. In another example, the user profile configuration 18 has an indicator designating a user selection of notification preferences implemented by the activity tracking device 10 (e.g., don't notify user during certain hours of the day such as work hours). The user profile configuration 18 can include an indicator designating user selection of activities available for recommendation to the user.

In one example, the activity tracking device 10 can have environmental information stored in the data store 14. The environmental information can include, for example, information on the weather. This information can include the chance of precipitation, temperature, or time of sunset. The environmental information can be based on actual real-time user environment. In another example, the environmental information is based on a predicted user environment at a future time when the user is scheduled for an activity. For example, if a user is scheduled to run outside in the afternoon, the environmental information can be used to predict that it may rain, thus the activity tracking device 10 can recommend indoor swimming or another indoor activity such as racquet ball based on the predicted user environment at the future time. In other examples, the activity tracking device 10 can have user calendar information and user nutritional intake information stored in the data store 14. Other examples of weather impacting recommended activity include temperature outside such that the activity tracking device 10 communicates to the user that it's either too cold or too hot/humid to go for run and in some cases it may communicate a warning that the weather conditions are dangerous. Also, based on the changing times for sunrise or sunset, this environmental information can be used by the activity tracking device 10 to adjust outside exercise schedule. The calendar information can also be used by the activity tracking device 10 for adjusting a run schedule based on a work meeting or family event, or other calendar entry. The nutritional intake information can be utilized by the activity tracking device 10 for determining how many calories burned versus calories consumed each day. This information allows the user to adjust their eating habits and exercise habits accordingly. For example, if a user increases their caloric intake, a corresponding increase in their exercise habits may be required to accommodate this change and vice versa.

The activity tracking device 10 includes a main processor 20 that is communicatively coupled with the data store 14. The main processor 20 processes operations of the activity tracking device 10. The main processor 20 can be a main device logic or microcontroller, in addition to other forms of processor, as would be readily understood by those of skill in the art.

As shown in FIGS. 2A and 2B, the main processor 20 can communicate directly with the data store 14 or indirectly with the data store 14 via an activity history analyzer 212. The activity history analyzer 212 can be in communication with the data store 14 and the main processor 20 such that the activity history analyzer 212 is configured to restore data to the data store 14. The activity history analyzer 212 is utilized to track the history of a user's activities with the activity tracking device 10. The information from the activity history analyzer 212 can be used in determining the historical activity parameters. The activity history analyzer 212 can be configured to restore the display of total number of steps recorded (e.g., day's total step count), calories, distance, progress toward goals (e.g., daily goals), activity parameters (e.g., active minutes), minimum user activity parameter, etc. after a battery is replaced. Whereas, the main processor 20 reads and analyzes the contents in the data store 14 (e.g., non-volatile memory) and restores the display of the clock and other information after the battery is replaced. Thus, the activity tracking device 10 does not lose any information after a battery is replaced. In particular, information/data is retained and analyzed immediately upon restoring of the power to the activity tracking device 10 after replacement of the battery.

In addition to the main processor 20, the activity tracking device 10 can optionally include a wireless microprocessor 21 that is coupled to the main processor 20 as shown in FIG. 1. The wireless microprocessor 21 is capable of doing similar computational requirements as the main processor 20, including processing of the wireless signals. In one example, the wireless microprocessor 21 can replace the main processor 20 (e.g., wireless microprocessor 21 processes wireless signals and performs all the computational requirements of the main processor 20).

In one example, the activity tracking device 10 can include a motion sensor 24 in communication or coupled with the main processor 20 that can employ a body motion sensing algorithm 211 such that the main processor 20 feeds data from the motion sensor 24 onto the body motion sensing algorithm 211. The body motion sensing algorithm 211 in conjunction with the main processor 20 is able to convert the data sensed by the motion sensor 24 into actual measurements used for determining a particular motion. In one example, the motion sensor 24 is formed of a group of sensors that provide different inputs to the main processor 20. In particular, the activity tracking device 10 can use a motion sensor 24 that senses acceleration in three dimensions (i.e., a 3-dimensional sensor). In another example, the activity tracking device 10 can use a motion sensor that senses/measures orientation (e.g., gyroscope) and/or pressure.

As shown in FIGS. 2A and 2B, another sensor in the activity tracking device 10 can be a magnetic sensor 26 (e.g., “Hall-effect sensor” for determining proximity of a magnetic field). The magnetic sensor can be employed to detect whether the activity tracking device 10 is coupled with a wristband accessory for example by detecting the proximity of the magnetic field and prompting the user to perform a selection based on the determination that the activity tracking device 10 is coupled to the wristband accessory. In another example, the activity tracking device 10 can employ a magnetic sensor 26 such as a magnetometer to determine the direction of the magnetic field for determining user orientation.

As shown in FIGS. 2A and 2B, the activity tracking device 10 can also include a clock 28 (e.g., real-time clock) that is controlled by the main processor 20 via a power management and time algorithm 213. Also, motivational display templates 30 and engagement messages 32 are selected and/or updated by the main processor 20 via an engagement and messaging algorithm 215 to be displayed on the display screen 12. The user profile configuration 18 (e.g., user's personal settings) and the device profile configuration 16 (e.g., device settings) can be set and/or updated by the main processor 20 via a device personalization algorithm 210 as shown in FIGS. 2A and 2B. In one example, the profile configurations (device or personal) 16, 18 can be controlled by the computing/mobile device 22. In particular, messages can be turned on or off by controlling settings in the profile configurations (device or personal) 16, 18 with the computing/mobile device 22. The access to settings is the same whether using a computing/mobile device or the activity tracking device 10. More particularly, these settings are controlled system-wide or can be configured by a particular administrator. For example, pre-set configurations may be controlled by the administrator and can be further adjusted by the administrator.

The activity tracking device 10 is configured to communicate wirelessly 38 or via wired communication 40 with a computing/mobile device 22 or an additional device. The wireless communication or connection 38 can be a radio frequency type communication. For example the radio frequency type communication is cellular, IEEE 802.11 format (wireless local area network (WLAN)), IEEE 802.15.1 format (Bluetooth®), IEEE 802.15 format (Wireless Personal Area Network (WPAN)), or Bluetooth® low energy wireless formats (e.g., Bluetooth® Smart, Bluetooth® 4.0, etc.). The wired communication 40 can be Universal Serial Bus (USB) format (e.g., USB 2.0 or USB 3.0 compatible). Examples of the additional device include a second activity tracking device (e.g., GPS), a cyclometer, or a weight scale, though the present invention is not limited to these specific examples. For example, the additional device can include any other device that has compatible protocols with the activity tracking device 10.

In one example, data can be transferred or communicated when the activity tracking device 10 is connected (wirelessly or wired) to the computing/mobile device 22 in order to connect to an external server 311. In accordance with one example embodiment, when the activity tracking device 10 is reconnected to the computing/mobile device 22, the data store 14 can be erased and reset with updated information from the external server 311. The computing/mobile device 22 can communicate with the external server 311 via the internet. In particular, the computing/mobile device 22 can communicate with the external server 311 which can provide a user personalized web portal. In one example, the data communication between the activity tracking device 10 and the external server 311 uses the same server that provides the user personalized web portal. In another example, the data communication (from the activity tracking device 10 to the external server 311) is performed by one server and a different server provides the user personalized web portal. For example, this can be implemented with two different internet addresses for each server. The communication with the activity tracking device 10 is through the computing/mobile device 22 to the external server 311 and allows for synchronization (i.e., “syncing”) of activity data. The computing/mobile device 22 and the activity tracking device 10 can display, using the web portal or dashboard, progress of communication or synchronization. In one example, the computing/mobile device 22 allows for uploading/synchronization while separately interacting with the activity tracking device 10. For example, the uploading/synchronization can occur while software applications (e.g., the Weather Channel®—weather.com) dealing with environment are interacting with the activity tracking device 10.

In one example, data can be transferred when the activity tracking device 10 is using Bluetooth® low energy. In this example, the activity tracking device 10 is placed a certain distance from the computing/mobile device 22 such that the activity tracking device 10 is able to synchronize with the external server 311 (e.g., back end system) via the computing/mobile device 22. For example, the distance between the activity tracking device 10 and the computing/mobile device 22 can be in the range from about zero feet to about two feet. In particular, the activity tracking device 10 may communicate and synch with the computing/mobile device 22 in the range of a few inches. In another example, arrangement of the activity tracking device 10 and the display of the computing/mobile device 22 is in such a way that it places the display in a line of sight of a user that is executing the positioning step.

The external server 311 supplies various system accesses to the activity tracking device 10 via the computing/mobile device 22. Some example systems or subsystems that the external server 311 can be comprised of include physical activity and health system 313, reward and gamification system 314, challenge system 315, program engagement system 316, user personal setting system 317, customer relationship management (CRM) system 318, and a social connection system 319. These systems all communicate with the personal activity tracker configuration settings 320 which keep track of a user activity in order to continually update the activity tracking device 10 whenever the activity tracking device 10 is synched with the external server 311.

A third party external server 312 supplies various third party data to the activity tracking device 10 via the computing/mobile device 22 and external server 311. In particular, the third party external server 312 feeds data/services that can modify/enhance the external server 311 and its systems or subsystems 313-320. The activity tracking device 10 is configured to communicate with third party applications, programs, or sites via the third party external servers 312 (e.g., external data and service providers). The third party external servers 312 are external data/service providers that feed health, physical, medical, nutritional or other information into the external server 311 (e.g., backend system) that affects/supplies data used by the external server 311 to then synchronize/update the activity tracking device 10. The third party external server 312 feeds data into the external server 311 to further customize the activity tracking device 10. For example, the third party external server 312 can include data coming from such software applications as RunKeeper®, MyFitnessPal® nutrition program, offsite medical diagnostics, etc. Generally, the third party external servers 312 relate to external data from other sources/companies that feed data into the external server 311 that can change the behavior of the activity tracking device 10. In particular, access to the activity tracking device 10 via the computing/mobile device 22 can include weather features such as a weather application (e.g., the Weather Channel®—weather.com). This access allows the weather application to send data to the computing/mobile device 22 which is sent to the activity tracking device 10 such as “weather is sunny, go for a run.” This can occur via the external server 311 or directly to the computing/mobile device 22 and/or to the activity tracking device 10. Other examples of third party communication applications or programs include nutrition logbook (e.g., Myfitnesspal®.com) that allows users to be able to track their eating habits and an exercise tracker program (e.g., Runkeeper®.com) that allows users to track their workouts while also providing social interactions with other members of the website. For example, by interfacing the activity tracking device 10 with the exercise tracker program, the activity tracking device 10 can message a user about other activities to perform such as skiing. Also, the activity tracking device 10 can interact with a calendar (e.g., Outlook®) such as automatically scheduling a walk where there is an opening.

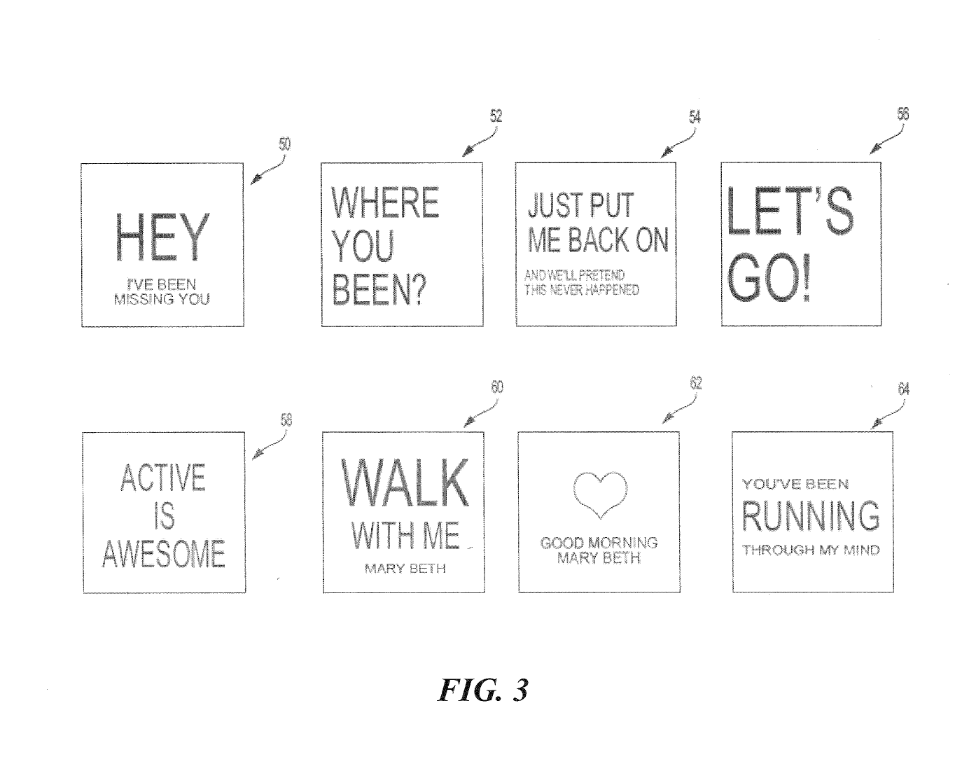

As shown in FIGS. 3-5B, the activity tracking device 10 can generate a message or messages on the display screen 12. For example, the activity tracking device 10 can display multiple messages in a stacked fashion. Initially, the display screen 12 can display an encouraging message. A button being pressed on the activity tracking device 10 or a time delay can cause the display screen 12 to display another message based on pre-determined or calculated rules. For example, the messages can be based on rules related to environmental information, user calendar information, user nutritional intake information, user profile configuration 18, time (e.g., trigger after X number of hours/days), or physical activity (or inactivity). For example, with regard to environmental information, the message can inform the user that it's sunny outside thus a great day to run outside, or that it's raining thus a great day to workout at the gym. With regard to user calendar information, in one example the user may be informed that there is an opening at a certain time to go for a run or that the running schedule should be adjusted to a later time due to a work meeting. In another example, a user's nutritional intake information message could inform the user of the number of calories to consume for a particular day or a recommended healthy option for lunch (e.g., “enjoy a salad today”). A message based on the user profile configuration 18 can provide a message updating the user with respect to a goal (such as trying to run X miles a day). Also, messages can be used to motivate the user depending on the user's activity parameter compared to the minimum user activity parameter. Messages can be based on a certain time. For example, the activity tracking device 10 can be triggered to send friendly messages at certain times of the day such as the morning (e.g., “good morning, ready for a jog?”). The messages can be based on activity or inactivity. For example, the messages can be based on inactivity and time. If the user doesn't walk/run in the next 12 hours, the activity tracking device 10 can be triggered to send a message to remind user to go for a walk/run.

As described above, messages can be customized for conservative or less conservative groups (tailored to an organization). Also, the messages can be customized for conservative or less conservative users. In particular, the display screen 12 can show a host of information such as various messages including how well the user is doing with respect to minimum desired parameters or goals or congratulatory messages based on accomplishments. The activity tracking device 10 can include message prompts to users regarding exercise by using encouraging messages or shaming messages based on recent activity. The messages can also vary based on the user's level of activity. For example, certain messages may be more helpful to motivate a highly active “marathon” type runner versus an average person. Also, some messages may be more helpful to a person that struggles to work out even once a week versus an average person. Also, the messages can change with respect to a user's current activity parameter based on the user's minimum user activity parameter. For example, at certain times it may be helpful for the display screen 12 to output motivating messages to get the user on track with respect to an expected level of activity based on minimum user activity parameter or at other times the messages may congratulate the user if the minimum user activity parameter is exceeded such that the user exceeded the user's expected level of activity.

For example, as shown in FIG. 3, some motivational display templates 30 as shown in screens 50, 52, 54, 56, and 58 (First Template through Eighth Template) include: “Hey I've Been Missing You,” “Where you been?,” “Let's Go!,” “Walk with me,” “You've been running through my mind,” etc.

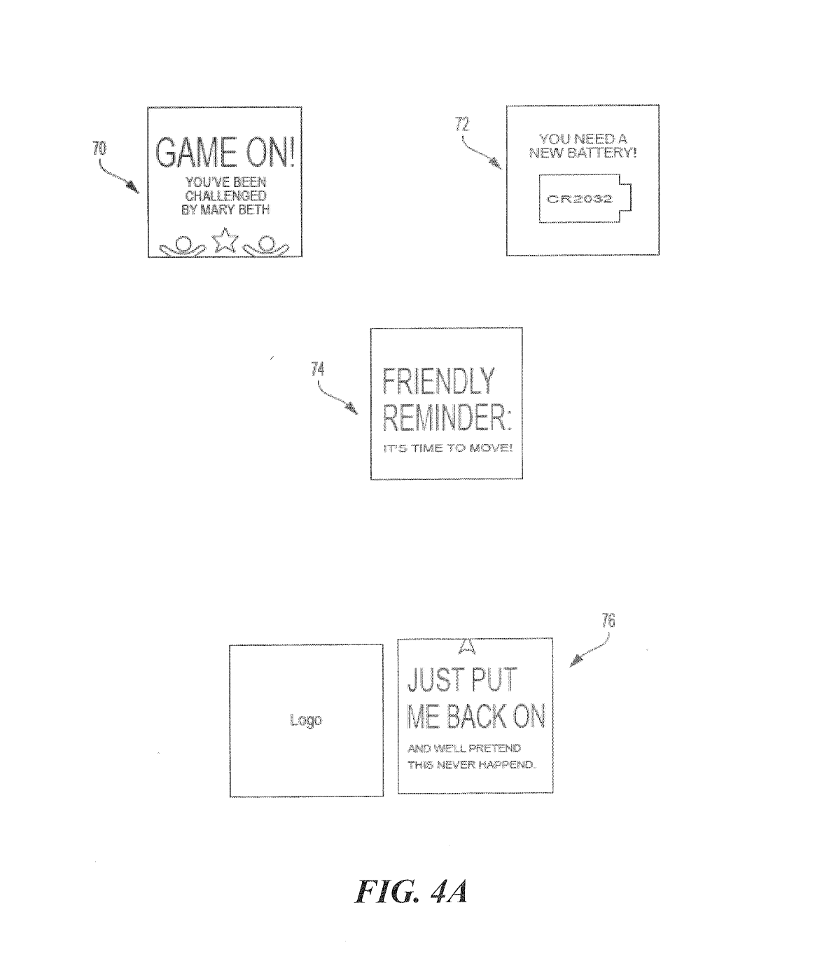

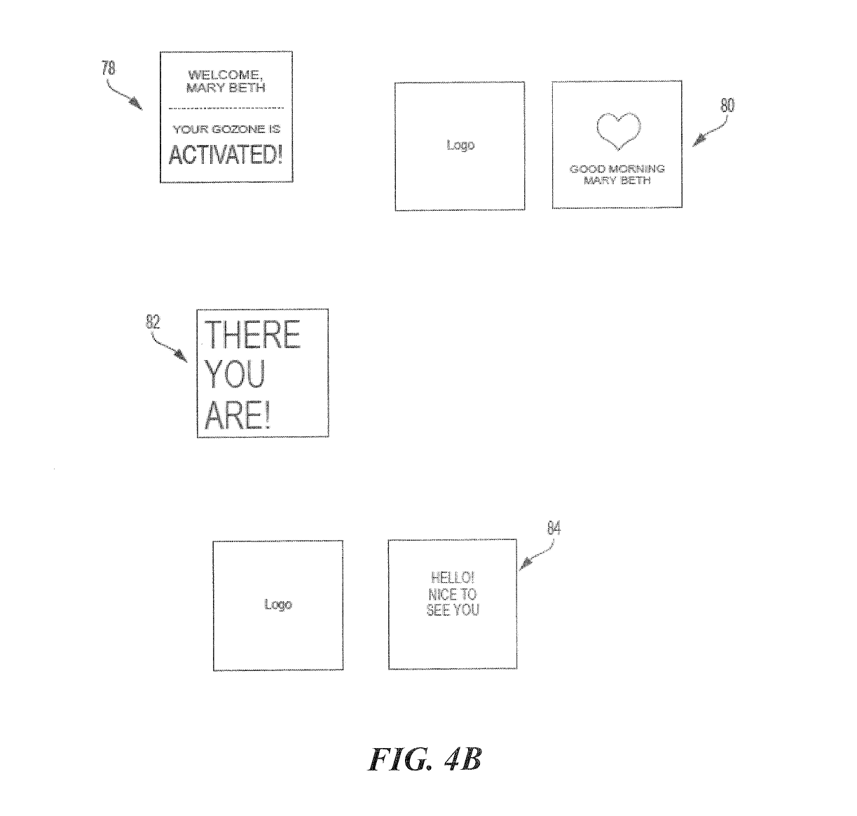

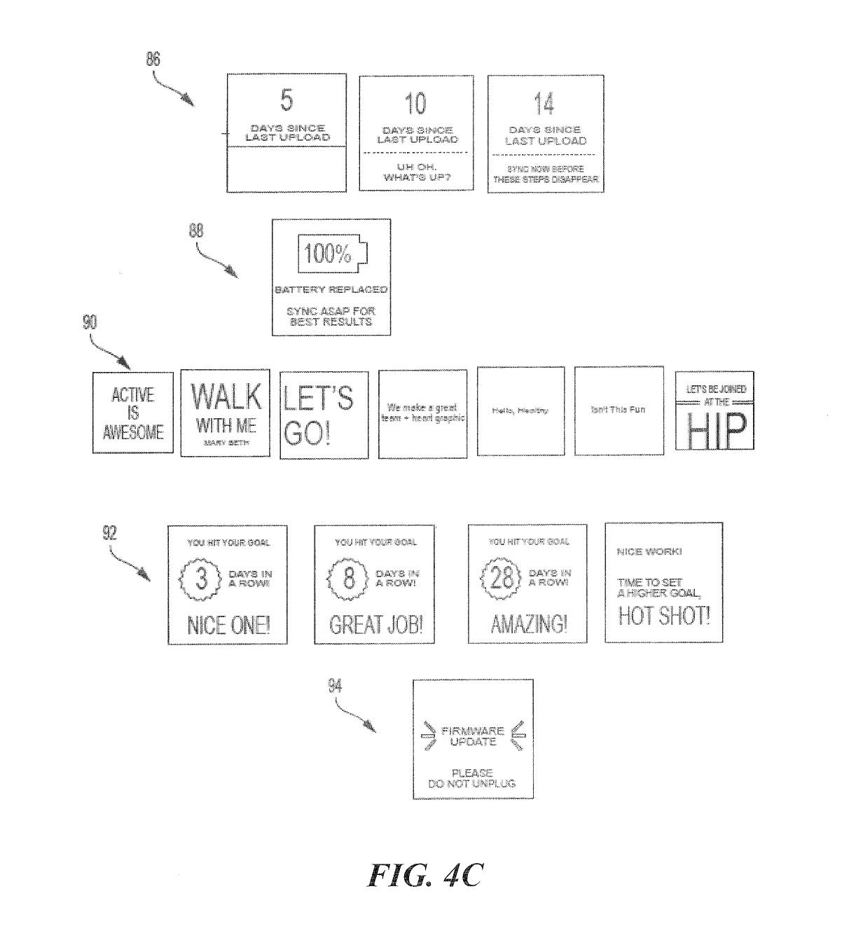

FIGS. 4A-4C illustrates a variety of scenario examples presented on the display screen 12 of the activity tracking device 10. The display screen 12 is configured to display a scenario based on at least one rule. A rule, or rules, can vary based on the particular scenario. However, each scenario is logically controlled by a set of rules such that the scenario functions how it's intended. Some of the examples include, a first scenario 70—activity tracking device 10 receives a challenge, second scenario 72—low battery, third scenario 74—encouraging screen (where you have taken <10 steps in the last 2 hours), fourth scenario 76—encouraging screen (not having worn the activity tracking device 10 >16 hours), fifth scenario 78—device was activated, sixth scenario 80—morning wake up, seventh scenario 82—taken off/put down for an hour or more, eighth scenario 84—moving after not moving for >8 hours, ninth scenario 86—upload reminder (shown as days since last upload), tenth scenario 88—battery just replaced, eleventh scenario 90—encouraging messages, twelfth scenario 92—user achieves goals, and thirteenth scenario 94—firmware update.

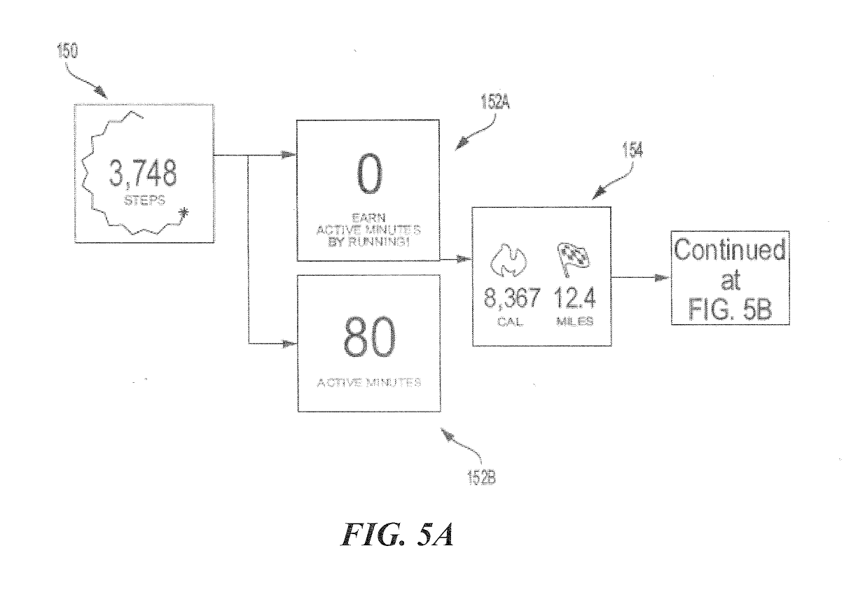

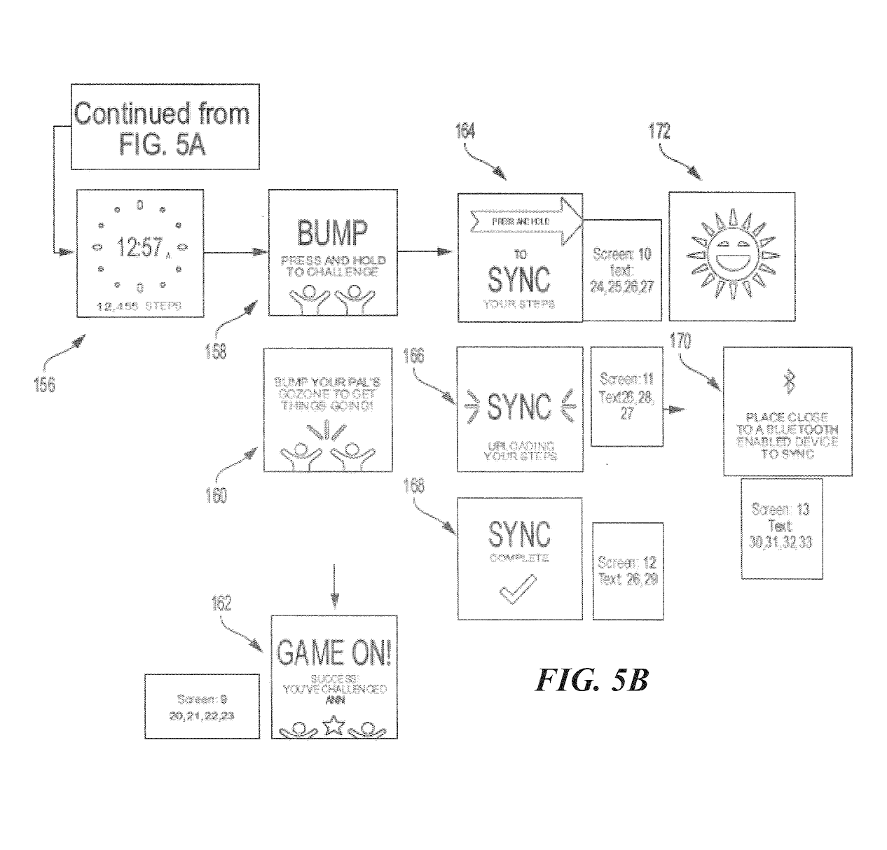

FIGS. 5A-5B illustrate computer display views of an example flow chart for using the activity tracking device 10. First 150, second 152A, third 152B, and fourth 154 screens are shown in FIG. 5A. The first screen 150 starts with a step screen showing total number of steps and how close the user is to reaching a goal. Second and third screens 152A, 152B display two alternatives: one displays zero earned activity parameters (e.g., active minutes) for running and the other screen displays 80 activity parameters (e.g., active minutes). A fourth Screen 154 depicts the calories and miles recorded for a user. A fifth screen 156 through the thirteenth screen 172 are shown in FIG. 5B. The fifth screen 156 displays a 24 hour clock. Seventh screen 158 illustrates initiation of bump feature by pressing and holding button. The activity tracking device 10 can continue to send a message to a user with regard to challenging another user such as “bump your pal's gozone to get things going!” from the eighth screen 160. The words “game on!” can be displayed as shown in the ninth screen 162. The steps of synchronization are shown as messages in screens ten 164 through twelve 168. The thirteenth screen 170 instructs the user to place the activity tracking device 10 close to a Bluetooth® enabled device for synchronization. A fourteenth screen 172 illustrates the ability for the display screen 12 to display a graphic message such as sunshine (e.g., communicate the weather to a user).

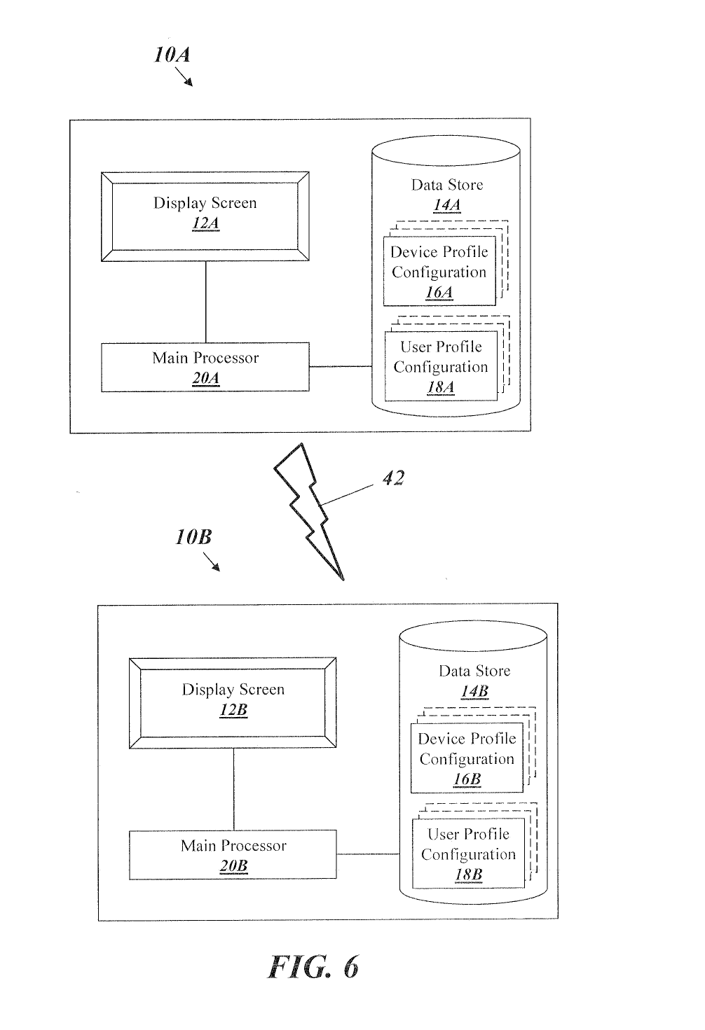

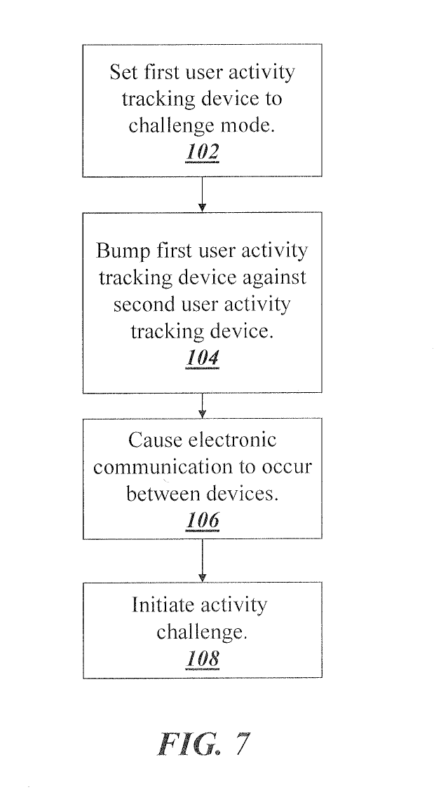

FIG. 6 illustrates the bumping action 42 and thereafter communication between a first activity tracking device 10A and a second activity tracking device 10B. FIG. 7 illustrates a flowchart depicting the steps of the method of bumping between the first activity tracking device 10A and the second activity tracking device 10B. In particular, this bumping action 42 initiates an activity challenge between at least two users. The method includes a first activity tracking device 10A that has a first user profile configuration 18A stored in a data store 14. A second activity tracking device 10B has a second user profile configuration 18B stored in a data store 14B. In step 102, the first activity tracking device 10A is set to a challenge mode. The first activity tracking device 10A and the second activity tracking device 10B are bumped against each other (step 104). This causes an electronic wireless communication from the bumping action 42 to occur between the first activity tracking device 10A and the second activity tracking device 10B (step 106). In step 108, the electronic communication initiates the activity challenge between the first activity tracking device 10A and the second activity tracking device 10B. In one example, this “bump” feature can be performed when the activity tracking device 10 is in “whisper mode.” The “whisper mode” enables peer-to-peer communications within a few inches.

In one example, a challenge is initiated between two users, the first user can subsequently challenge other users in a sequential fashion where the challenged users can be in the same challenge. In particular, a user challenges another user regarding “most steps for the next hour” such that user A challenges user B at 9 am and user A challenges user C at 9:30 am. User A challenges user D at 10:30 am. When user A synchronizes device data to the system, users A, B, and C will be in a challenge from 9 am to 10 am and users A and D will be in separate challenges from 10:30 am to 11:30 am. However, if the challenge is regarding “most steps today,” then the scenario above would dictate that users A, B, C, and D can be in same challenge.

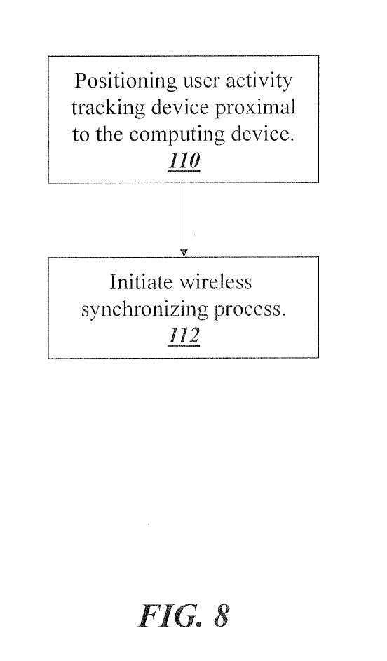

FIG. 8 illustrates another example method of implementation of the activity tracking device 10. This is a method of synchronizing an activity tracking device 10 with a computing/mobile device 22. In step 110, the activity tracking device 10 is positioned proximal to the computing/mobile device 22. For example, proximal can include a distance in the range from about zero feet to about two feet or can be as small as a few inches. In another example, where the synchronization is occurring via a wire, proximal is based on the maximum length of the wire between the activity tracking device 10 and the computing/mobile device 22. Other ranges for proximal can be used in order to synchronize the activity tracking device 10 with the computing/mobile device 22 as would be readily appreciated by those of skill in the art. A wireless synchronizing process is initiated in step 112. For example, the step of initiating the wireless synchronizing process includes a user pressing a button on the activity tracking device 10 for a selected time duration. In another example, a method synchronizes an activity tracking device 10 with a computing/mobile device 22 automatically without requiring a user to press a button. Synchronizing can be initiated when the activity tracking device 10 is electronically coupled to the computing/mobile device 22 via a wire (e.g., USB) or the synchronizing can occur wirelessly (e.g., Bluetooth®) between the activity tracking device 10 and the computing/mobile device 22. In another example, the activity tracking device 10 and the computing/mobile device 22 can be arranged such that the computing/mobile device 22 is in proximity to the user. For example, proximity between the user and the computing/mobile device 22 can include a distance in the range from about zero feet to about two feet or can be as small as a few inches. In one example, this range can be based on the user's line of sight such that the user can view the computing/mobile device 22 while exercising with the activity tracking device 10. Other ranges for proximity can be used within the scope of the present invention as would be readily appreciated by those of skill in the art.

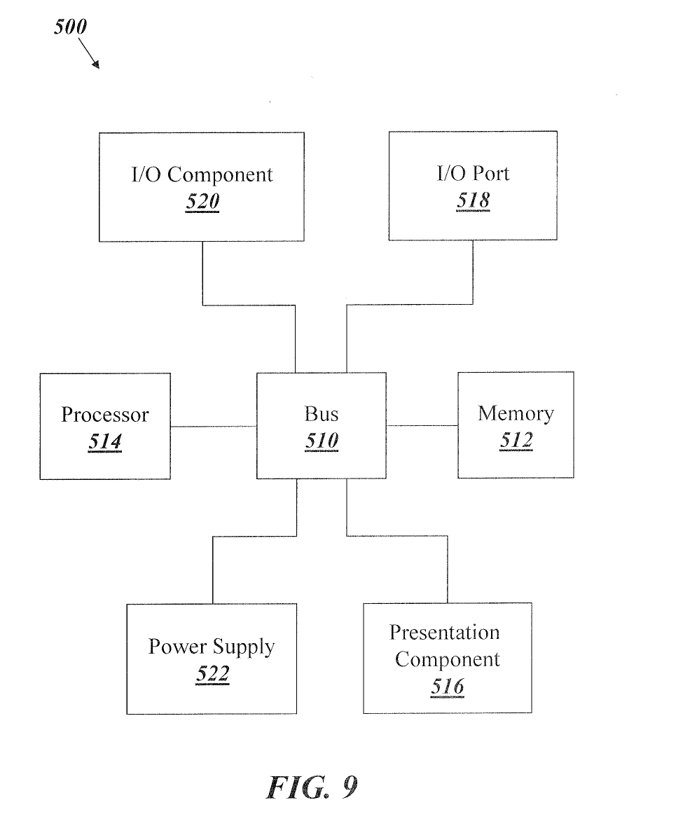

FIG. 9 illustrates an example of a computing device 500 for implementing aspects of the illustrative methods and systems of the present invention such as the activity tracking device 10 or the computing/mobile device 22. The computing device 500 is merely an illustrative example of a suitable computing environment and in no way limits the scope of the present invention. A “computing device,” as represented by FIG. 9, can include a “workstation,” a “server,” a “laptop,” a “desktop,” a “hand-held device,” a “mobile device,” a “tablet computer,” or other computing devices, as would be understood by those of skill in the art. Given that the computing device 500 is depicted for illustrative purposes, embodiments of the present invention may utilize any number of computing devices 500 in any number of different ways to implement a single embodiment of the present invention. Accordingly, embodiments of the present invention are not limited to a single computing device 500, as would be appreciated by one with skill in the art, nor are they limited to a single type of implementation or configuration of the example computing device 500.

The computing device 500 can include a bus 510 that can be coupled to one or more of the following illustrative components, directly or indirectly: a memory 512, one or more processors 514, one or more presentation components 516, input/output ports 518, input/output components 520, and a power supply 522. One of skill in the art will appreciate that the bus 510 can include one or more busses, such as an address bus, a data bus, or any combination thereof. One of skill in the art additionally will appreciate that, depending on the intended applications and uses of a particular embodiment, multiple components can be implemented by a single device. Similarly, in some instances, a single component can be implemented by multiple devices. As such, FIG. 9 is merely illustrative of an exemplary computing device that can be used to implement one or more embodiments of the present invention, and in no way limits the invention.

The computing device 500 can include or interact with a variety of computer-readable media. For example, computer-readable media can include Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices that can be used to encode information and can be accessed by the computing device 500.

The memory 512 can include computer-storage media in the form of volatile and/or nonvolatile memory. The memory 512 can be removable, non-removable, or any combination thereof. Exemplary hardware devices are devices such as hard drives, solid-state memory, optical-disc drives, and the like. The computing device 500 can include one or more processors 514 that read data from components such as the memory 512, the various I/O components 520, etc. Presentation component(s) 516 present data indications to a user or other device. Exemplary presentation components 516 include a display device, speaker, printing component, vibrating component, etc. The I/O ports 518 can allow the computing device 500 to be logically coupled to other devices, such as I/O components 520. Some of the I/O components 520 can be built into the computing device 500. Examples of such I/O components 520 include a microphone, joystick, recording device, game pad, satellite dish, scanner, printer, wireless device, Bluetooth® device, networking device, and the like.

One of skill in the art will appreciate a wide variety of ways to modify and alter the system and method of FIGS. 1-9, as well as the various components with which it interacts. For example, the one or more computing systems can be implemented according to any number of suitable computing system structures. Furthermore, some or all of the information contained in the one or more data sources alternatively can be stored in one or more remote databases (e.g., cloud databases, virtual databases, and any other remote database).

In some embodiments, it may be desirable to implement the method and system using multiple iterations of the depicted modules, controllers, and/or other components, as would be appreciated by one of skill in the art. Furthermore, while some modules and components are depicted as included within the system, it should be understood that, in fact, any of the depicted modules alternatively can be excluded from the system and included in a different system. One of skill in the art will appreciate a variety of other ways to expand, reduce, or otherwise modify the system upon reading the present specification.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. Within this specification embodiments have been described in a way which enables a clear and concise specification to be written, but it is intended and will be appreciated that embodiments may be variously combined or separated without parting from the invention. It is intended that the present invention be limited only to the extent required by the appended claims and the applicable rules of law.

It is also to be understood that the following claims are to cover all generic and specific features of the invention described herein, and all statements of the scope of the invention which, as a matter of language, might be said to fall therebetween.

What is claimed is:

1. A method of operating activity tracking devices, the method comprising:
a first user having a first activity tracking device comprising a first display screen, a first data store, a first main processor, and a first user profile configuration stored in the first data store;
a second user having a second activity tracking device comprising a second display screen, a second data store, a second main processor, and a second user profile configuration stored in the second data store;
the first user setting the first activity tracking device to a challenge mode;
the first user and the second user bumping the first activity tracking device and the second activity tracking device against each other and causing an electronic wireless communication to occur between the first activity tracking device and the second activity tracking device, wherein the electronic wireless communication initiates an activity challenge between the first activity tracking device and the second activity tracking device.

2. The method of claim 1, wherein the step of bumping is performed when the first activity tracking device and the second activity tracking device are in whisper mode to enable peer-to-peer communications with a short range.

3. The method of claim 1, wherein a third user having a third activity tracking device is added to the activity challenge when the first user of the first activity tracking device, or the second user of the second activity tracking device, challenges the third user.

4. The method of claim 1, wherein the activity challenge is a challenge between the first user and the second user of actual user activity measured by the first activity tracking device and the second activity tracking device as data that comprises number of steps data and duration data.

5. The method of claim 1, wherein the first display screen and the second display screen are configured for displaying initiation of the activity challenge between the first activity tracking device and the second activity tracking device.

6. The method of claim 5, wherein the first display screen and the second display screen are further configured to display one or more of total number of steps taken by the first user and the second user, activity parameter, total number of calories burned, total distance travelled by the first user and the second user, progress indicator toward user daily steps goal, physical activity intensity indicator, synchronization progress indicator, or a clock with a current time.

7. The method of claim 1, the first activity tracking device and the second activity tracking device are pedometers.

8. A method of operating an activity tracking device, the method comprising:
the activity tracking device comprising a display screen, a data store, a main processor, and a user profile configuration stored in the data store;
positioning the activity tracking device proximal to a computing device;
initiating a synchronizing process; and
the activity tracking device synchronizing with the computing device.

9. The method of claim 8, wherein the step of initiating the synchronizing process comprises a user pressing a button on the activity tracking device for a selected time duration.

10. The method of claim 8, wherein the step of positioning requires an arrangement of the activity tracking device and the computing device in such a way that places the computing device in proximity to a user executing the step of positioning.

11. The method of claim 8, wherein the synchronizing process is wired or wireless.

12. The method of claim 8, wherein a synchronization progress indicator is displayed on the activity tracking device and/or the computing device.

13. The method of claim 8, wherein a minimum user activity parameter is configured into the activity tracking device during the synchronizing process.

14. The method of claim 13, wherein the minimum user activity parameter is determined based on one or more historical activity parameters resulting from actual user activity as tracked by the activity tracking device, stored in the data store, and configured in the user profile configuration.

15. The method of claim 8, wherein proximal is a distance in a range from zero feet to two feet.

16. The method of claim 8, wherein the activity tracking device is configured to synchronize with an external server via the computing device.
